(19) United States
(12) Patent Application Publication
(10) Pub. No.: US 2002/0088182 A1
(43) Pub. Date: Jul. 11, 2002

(54) Weather strip for an opening with which a motor-driven closure element is associated

(75) Inventor: Domenico Arabino, Salerno (IT)

Correspondence Address: SUGHRUE, MION, ZINN, MACPEAK & SEAS, PLLC, 2100 Pennsylvania Avenue, N.W., Washington, DC, 20037-3213, US

(73) Assignee: METZELER AUTOMOTIVE PROFILE SYSTEMS ITALY S.P.A.

(21) Appl. No.: 10/038,586

(22) Filed: Jan. 8, 2002

(30) Foreign Application Priority Data
Jan. 9, 2001 (IT) TO2001A000007

(51) Int. Cl. E05F 15/02; E05F 15/10

(52) U.S. Cl. 49/489.1

(57) ABSTRACT

The weather strip comprises a securing portion which has a tubular portion or compartment in which is defined a transversely elongate passage in which is arranged, with clearance, a pressure-sensitive element which comprises a pair of flexible facing electrically conductive strips separated by electrically insulating elements interposed between the lateral longitudinal edges of the strips. A principal wall of the compartment is provided with a projection which faces the transversely intermediate portion of an electrically conductive strip of the sensitive element and which is formed on the wall of the compartment which, in the fitted state of use of the weather strip, faces the edge of the opening. The arrangement is such that, when in use, an obstruction interposed between the closure element which is associated with the opening and the weather strip is capable of producing a resilient deformation of the compartment, which tends to cause local contact between the transversely intermediate portions of the electrically conductive strips.

### DESCRIPTION

The present invention relates to a weather strip for an edge of an opening, for example, a window opening or an opening in the roof of a motor-vehicle, with which a movable, motor-driven closure element is associated.

More particularly, the invention relates to a weather strip comprising:

a securing portion which is suitable for being coupled to the edge and which has, on the side that, when in use, faces the opening, a tubular portion or compartment in which is defined a transversely elongate passage, in which is arranged with clearance a pressure-sensitive element which comprises a pair of facing flexible electrically conductive strips separated by electrically insulating elements interposed between the lateral longitudinal edges of the strips;

a principal wall of the compartment being provided with a substantially longitudinal and central projection which faces the transversely intermediate portion of an electrically conductive strip of the sensitive element;

the arrangement being such that, when in use, an obstruction interposed between the closure element, which is associated with the opening, and the weather strip is capable of producing a resilient deformation of the compartment, which tends to cause local contact between the transversely intermediate portions of the electrically conductive strips.

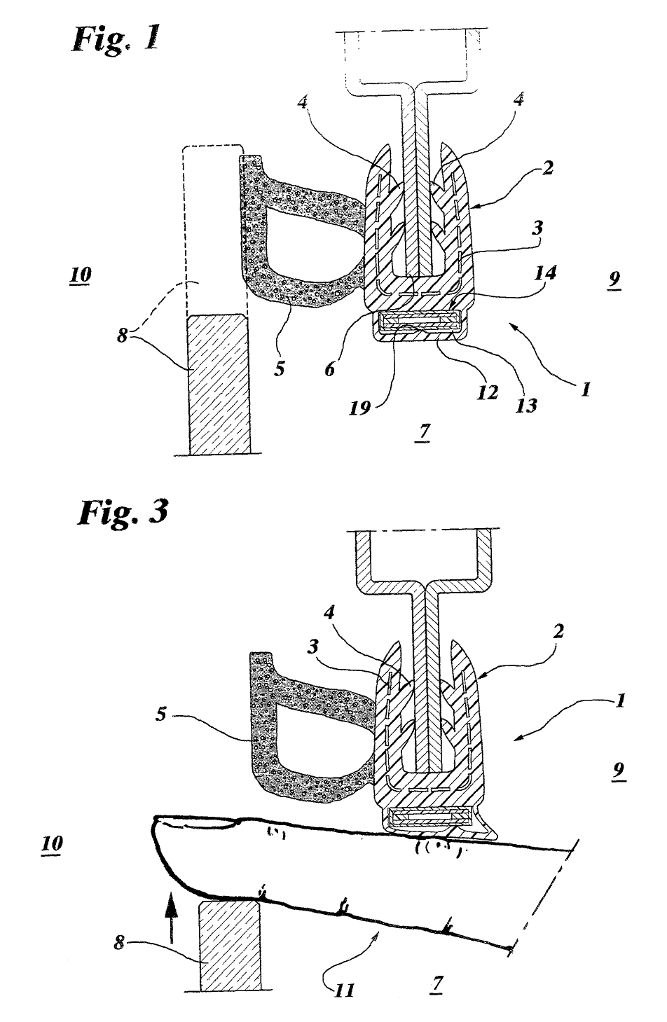

A weather strip of this type, produced according to the prior art, is shown in FIGS. 1, 3 and 4, in which the weather strip is generally designated 1. The weather strip 1 comprises a securing portion 2 comprising a substantially U-shaped profile section of elastomer material which is provided with an internal metal reinforcement 3. A plurality of integral fins 4 extend from the internal faces of the wings or flaps which face the securing profile section 2.

The weather strip 1 further comprises a sealing profile section 5, for example, a tubular profile section, which extends laterally from the external face of a wing or flap of the securing profile section 2. In known manner, the tubular sealing profile section 5 can be produced from an elastomer material different from that of the securing profile section.

When in use, the weather strip 1 is fitted to a portion of an edge 6 of an opening 7, for example, a window or an opening in the roof of a motor vehicle, with which a movable, motor-driven closure element 8, for example, a pane of glass, or the like, is associated in known manner. This closure element can separate an internal space 9, for example, the passenger space of a motor vehicle, from the external surroundings 10, and can be moved into a plane which is slightly offset relative to the plane of the edge to which the weather strip 1 is fitted. In the closed state (shown dashed in FIG. 1), the movable element 8 presses on the sealing profile section 5 of the weather strip 1.

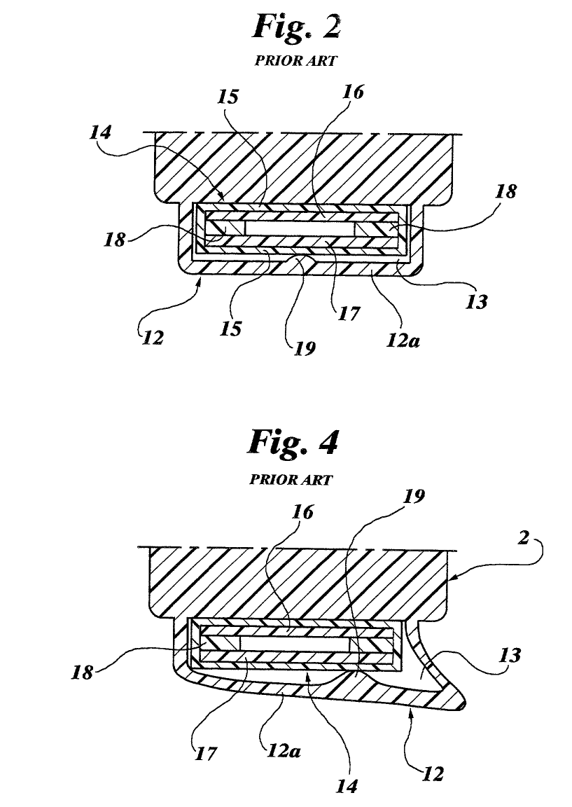

In order to be able to detect an operational state in which, during closing travel of the element 8, an obstruction 11 (FIG. 3) is interposed between the upper edge of the closure element 8 and the lower portion of the weather strip 1, and in order to bring about automatically the stopping or the reversal of the movement of the closure element 8, the weather strip 1 according to the prior art has, on the side that, when in use, faces the opening 7, a tubular portion or compartment 12 (which is particularly apparent in FIGS. 1 and 4). There is defined in this compartment a transversely elongate passage 13, in which is arranged with clearance a pressure-sensitive element 14. This element, which is drawn to a greatly enlarged scale in FIGS. 2 and 4, comprises a pair of electrically conductive strips 16, 17 which are arranged facing an insulating cover 15 and separated by electrically insulating elements 18 which are interposed between the lateral longitudinal edges thereof.

As will be better appreciated from FIG. 4, a lower principal wall 12a is provided with a substantially longitudinal and central projection 19 which extends in the passage 13 and which faces the transversely intermediate portion of the lower electrically conductive strip 17 of the sensitive element 14.

The arrangement is such that if, when in use, an obstruction 11 is interposed between the closure element 8 and the weather strip 1, it can produce a resilient deformation of the compartment 12, as shown in FIGS. 3 and 4, which tends to cause local contact between the transversely intermediate portions of the electrically conductive strips 16 and 17. This contact between the strips substantially corresponds to the closing of a switch and can be detected by a suitable circuit in order to cause the stopping or reversal of the movement of the closure element 8. The projection 19 of the lower wall 12a of the compartment 12 has the function of concentrating the stress on the transverse central portions of the electrically conductive strips of the sensitive element 14.

In the weather strip according to the above-described prior art, however, it is possible, further to the interposing of an obstruction between the closure element 8 and the weather strip, for the compartment 12 thereof to be deformed in the manner illustrated in FIG. 4, that is to say, in such a manner that the projection 19 is transversely displaced towards one end of the cross-section of the sensitive element. In this condition, the projection 19 may be unable to produce the contact between the electrically conductive strips 16 and 17 of the sensitive element 14 and the stopping or reversal of the movement of the closure element 8.

The objective of the present invention is to provide a weather strip of the type described in the introduction which would overcome the above-described disadvantage.

This and other objectives will be fulfilled according to the invention by means of a weather strip of the above-defined type, characterized in that the above-mentioned projection is formed on the wall of the compartment which, in the fitted state of use of the weather strip, faces the edge of the above-mentioned opening.

Further features and advantages of the invention will be appreciated from the detailed description which follows and which is given purely by way of non-limiting example with reference to the appended drawings, in which:

FIG. 1, as already described, is a sectional view of a weather strip according to the prior art, shown in a rest state;

FIG. 2, as has similarly already been described, is a partial sectional view, drawn to an enlarged scale, of a portion of the weather strip according to the prior art illustrated in FIG. 1;

FIG. 3, as has similarly already been described, is a view which is similar to that shown in FIG. 1 and depicts the weather strip according to the prior art in a state in which an obstruction is interposed between the weather strip and the closure element associated with the opening;

FIG. 4, as already described, is similar to FIG. 2 and depicts, drawn to an enlarged scale and as a sectional view, a portion of the weather strip according to the prior art in the operational state shown in FIG. 3; and

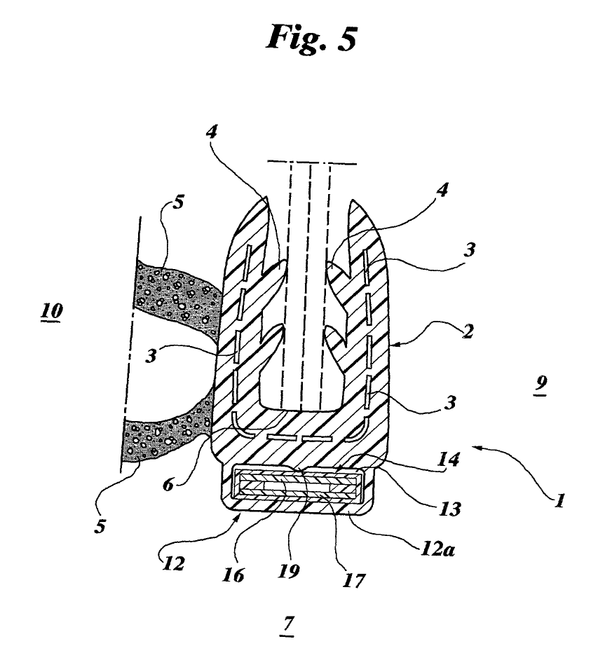

FIG. 5 is a sectional view, drawn to an enlarged scale, of a weather strip according to the invention.

In FIG. 5, the same reference numerals have again been attributed to parts and elements which have already been described with reference to the preceding Figures.

Very briefly, in the weather strip according to the invention, the projection 19 which extends towards the sensitive element 14 in the passage 13 of the compartment 12 is not produced on the wall 12a which is intended to be pressed on by an interposed body on the path of the closure element 8, but rather on the opposing wall, or otherwise on the wall which, in the state in use, faces the edge 6 of the opening 7.

Thanks to that feature, when a body is interposed between the closure element 8 and the weather strip 1 according to the invention, the projection 19 which is intended to promote the contact between the electrically conductive strips of the sensitive element 14 does not in practice change its position relative to the transversely intermediate portion of those strips.

That feature prevents unsuccessful operations by the safety device which is intended to carry out the stopping or the reversal of the movement of the closure element 8.

Naturally, the principle of the invention remaining the same, the embodiments and the production details can be extensively varied in respect of what has been described and illustrated purely by way of non-limiting example, without thereby departing from the scope of the invention as defined in the appended claims.

What is claimed is:

1. Weather strip for an edge of an opening, with which is associated a movable, motor-driven closure element, the weather strip comprising: a securing portion which is suitable for being coupled to the edge and which has, on the side that, when in use, faces the opening, a tubular portion or compartment, in which is defined a transversely elongate passage, in which is arranged with clearance a pressure-sensitive element which comprises a pair of flexible facing electrically conductive strips separated by electrically insulating elements interposed between the lateral longitudinal edges of the strips; a principal wall of the compartment being provided with a substantially longitudinal and central projection, which faces the transversely intermediate portion of an electrically conductive strip of the sensitive element; the arrangement being such that, when in use, an obstruction interposed between the closure element which is associated with the opening and the weather strip is capable of producing a resilient deformation of the compartment, which tends to cause local contact between the transversely intermediate portions of the electrically conductive strips; said projection being formed on the wall of the compartment which, in the fitted state of use of the weather strip, faces the edge of the opening.
